(19) United States
(12) Patent Application Publication
(10) Pub. No.: US 2010/0033340 A1
(43) Pub. Date: Feb. 11, 2010

(54) Fluid-Technical Assembly Having an Optical Waveguide

(75) Inventor: Grzegorz Bogdanowicz, Ostfildern (DE)

Correspondence Address: HOFFMANN & BARON, LLP, 6900 JERICHO TURNPIKE, SYOSSET, NY, 11791, US

(73) Assignee: FESTO AG & CO. KG, Esslingen (DE)

(21) Appl. No.: 12/311,652

(22) PCT Filed: May 12, 2007
(86) PCT No.: PCT/EP2007/004237

§ 371 Date: Apr. 7, 2009

(51) Int. Cl. G08B 5/00

(52) U.S. Cl. 340/815.43

(57) ABSTRACT

A fluid power device comprises a state display unit (23) having a light source (24) concealed in the device and furthermore a light guide (25) to conduct light signals to a display zone (26). The light source (24) emits polychromatic light, which is so filtered by a color filter (42) that at the display zone a certain visible color of light appears.

The invention relates to a fluid power device comprising at least one state display unit which possesses a light source concealed in the device and a light guide for conducting the light signals of the light source to a display zone on the outer side of the device.

A fluid power device of this type in the form of a valve device is disclosed in the German patent publication DE 201 05 982 U1. It comprises several juxtaposed electrically operated valve units, whose operational state is indicated visually by a respective state display unit. In a housing disposed terminally on the arrangement of the valve units there is a board carrying several LEDs from which a respective light guide leads to a display zone provided on the outside of the valve device. The light signals emitted by the LEDs pass through the associated light guide to the display zone, the light guide offering the possibility of independently varying the position where the light source is placed.

The European patent publication EP 0 606 048 A1 also describes a fluid power device fitted with valve units, a printed circuit board being disposed in a valve support and having an LED serving for displaying the switching state. The LED has a display zone fitting through an opening in the valve support so that its light signals may be viewed directly without an additional light guide.

In the case of this prior art the light signals visible for the observer always produce the same optical impression. It is consequently frequently difficult to distinguish certain signals so that misunderstandings in assessing the light signals may occur.

One object of the present invention is to adopt measures which improve the possibility of identifying optical state display signals.

In order to achieve this aim in the case of a fluid power device of the type initially mentioned there is a provision such that the light source of the state display unit is designed for emitting polychromatic light and that in the beam path of the light between the light source and the display zone at least one color filter is arranged determining the color, visible at the display zone, of the light signals.

Accordingly the color visible for the observer at the display zone of the light signals is not limited to one single light color. Owing to the color filter disposed on the path of the light beam the light color ultimately visible may be varied. The polychromatic light from the light source provides a large color spectrum from which the light color desired can be selected by the color filter. Thus there is for example the possibility of providing state display units with different color filters in a fluid power device in order to emit light signals differing in color according to the current operational state. If the fluid power device is for example in the form of a valve device having several valve units, the individual valve units—for example in accordance with their importance or their purpose of use—may have different display colors assigned to them. The light source may in this case always be of the same sort, recourse being particularly had to an LED emitting polychromatic white light.

Preferably the color filter is arranged replaceably on the fluid power device so that the displayed color may be varied simply by changing the color filter. Several color filters may belong to the fluid power device having mutually different light colors so that they are responsible for producing mutually different light colors and are selectively installed and employed in accordance with the particular application.

In principle the light guide—instead of the term “light guide” the term “light wave conductor” be often employed—is itself so designed that it functions as a color filter. In the simplest case this is achieved by a suitable coloration with a shade of color corresponding to that of the light color to be displayed. If the displayed color is to be altered, this can be achieved just by an exchange of the entire light guide.

However it is considered to be most advantageous to have a design whose color filter is a self-contained color filter element in addition to the light guide. If there is here the possibility of replacement of the color filter element, it is possible then to make available different light colors while still maintaining the light guide by simply using one of several color filter elements, which have mutually different optical filtering effects. In this case it is an advantage for the color filter element to be arranged directly on the light guide, more particularly in such a manner that the light guide supports the color filter element.

If a separate color filter element is present, the light guide will preferably consist of a material which conducts the light of the entire visible wavelength spectrum without filtration. More particularly, recourse may be had to a colorless transparent synthetic resin material. Absent an additional color filter such a light guide would at the display zone supply a light color directly corresponding to the light color of the light source. Owing to the additional color filter element this light color may be altered without any problems.

It is furthermore convenient for the color filter element to be arranged on the light guide using a readily releasable plug connection. This facilitates rapid exchange. For instance a detent connection is possible in order to ensure a non-detachable anchoring in place.

The color filter element is best seated on an inner terminal section associated with the light source and/or an outer terminal section, arranged on the display zone, of the light guide. In particular when the color filter element is disposed on the inner terminal section of the light guide, such terminal section may be in the form of a pin and receive a dome-like color filter element.

One and the same fluid power device can be provided with several functional units, which each comprise one light source and one light guide. Several light guides may if required be associated with one common color filter. Furthermore several light guides can be collected together in a single light guide element to constitute one structural unit. Such an arrangement is particularly to be recommended in the case of valve devices, which have several valve units, which may then be provided with such a light guide element.

Further advantageous measures of the invention will be explained in the following detailed account of one working embodiment of the novel fluid power device with reference to the accompanying drawings.

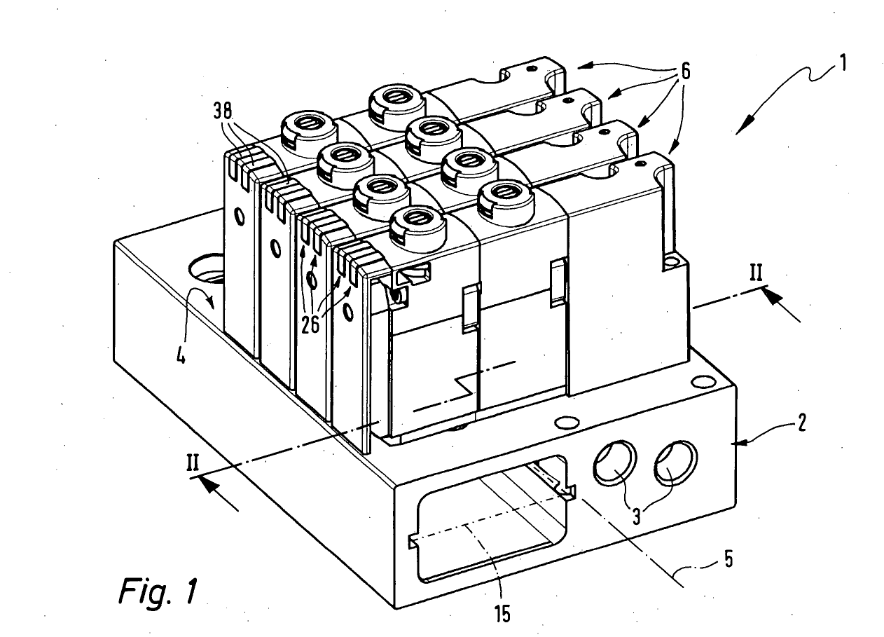

FIG. 1 represents a fluid power device designed in accordance with the invention in a perspective elevation.

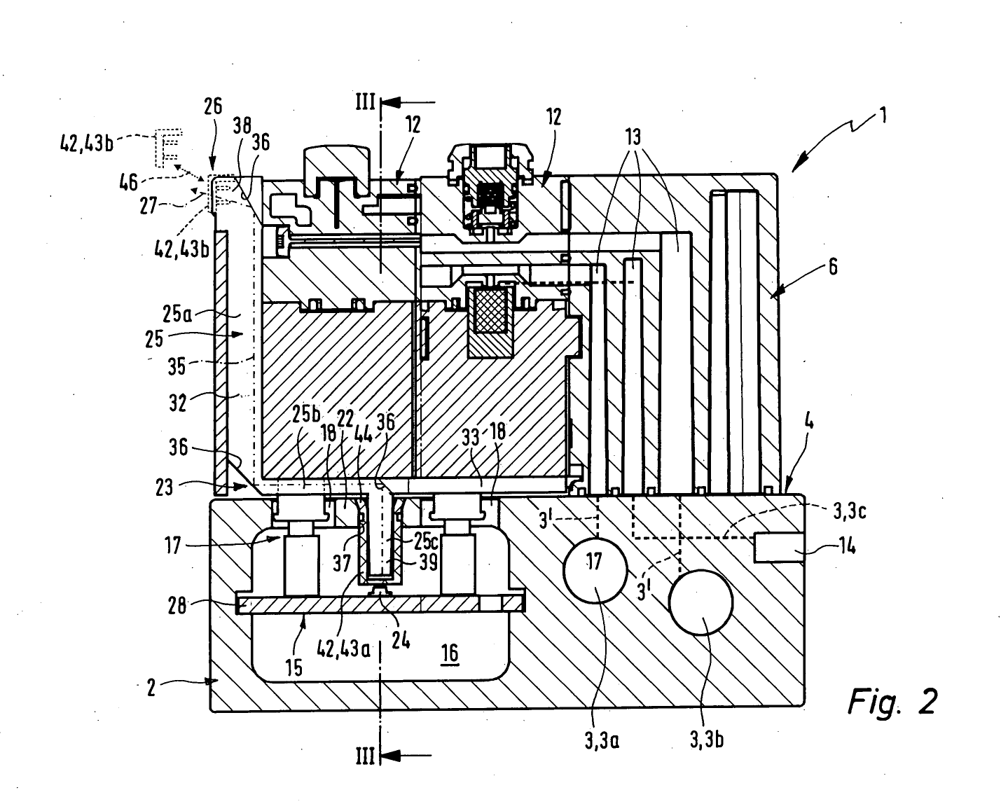

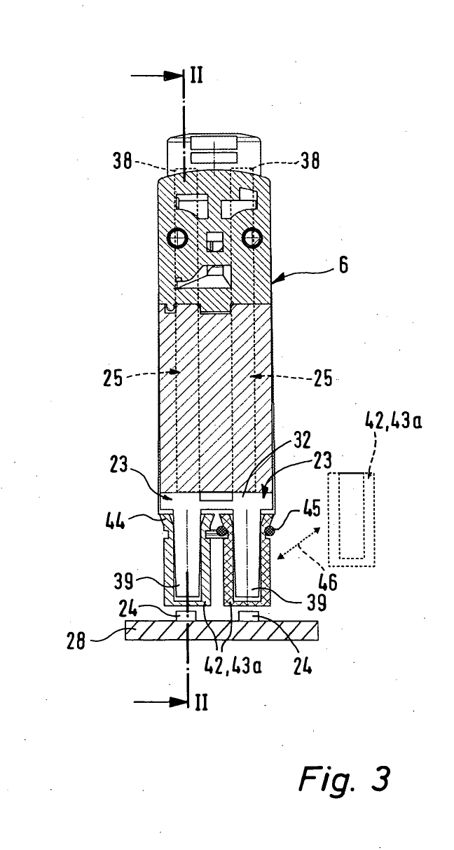

FIG. 2 shows the device according to FIG. 1 in a section taken on the line II-II in FIGS. 1 and 3.

FIG. 3 shows only a partial view of the fluid power device in a section on the section line III-III.

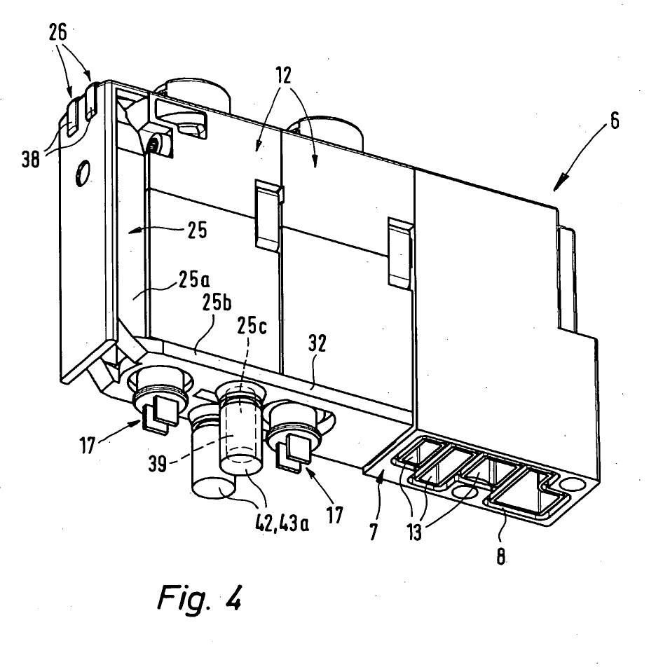

FIG. 4 is a perspective separate view of a valve unit, belonging to the device in accordance with FIGS. 1 through 3, looking toward the bottom at a slant.

A significant feature of the present invention resides in the configuration of a state display unit in the case of a fluid power device of any desired type. The description of one working example is now presented with reference to a valve device 1 serving for the control of fluid flows without implying any limitation. Examples for further fluid power devices embodying the invention include vacuum producing devices, servicing device for the treatment of compressed air or drive devices such as rotary or linear drives. The following basic principles apply for all types of fluid power devices.

The valve device 1 comprises a valve support 2, which is of plate-like or if required segmented configuration, which has several valve support ducts 3 extending through it, which in FIG. 2 are only indicated in chained lines in part. The valve support 2 defines a component mounting face 4 on which mounts several electrically operated valve units 6 juxtaposed in the direction of a principal axis 5 of the valve device 1. In FIG. 4 one such valve unit 6 is illustrated separately, it being possible to see the bottom base face 7 which is placed on the component mounting face 4 with sealing means 8 placed in between.

Each valve unit 6 comprises at least one electrically operated control valve 12, there being two such control valves 12 per valve unit 6 in the example. They appear differently in FIG. 2 since the section plane is offset.

In the case of the control valves 12 it is a question for example of solenoid valves, although other types of valves could be employed, as for example piezoelectric valves or electrostatically operated valves

The control valves 12 communicate with valve ducts 13 extending in the interior of the valve unit 6 and opening at the base face 7 of the valve unit 6 so that they are connected in the desired arrangement with the valve support ducts 3 opening there.

The valve support ducts 3 include for example a supply duct 3a able to be joined with a pressure source and at least one discharge duct 3b able to be connected with a pressure sink, as for example the atmosphere. These two ducts 3a and 3b run through the valve support 2 in the direction of the principal axis 5 and open by way of branch ducts 3′ at each section of the component mounting face 4, on which a valve unit 6 may be mounted. Furthermore at these face sections in each case at least one individual working duct 3c of the valve support ducts 3 opens, which at the other end opens at a lateral outer side of the valve support 2 where it has a connection port 14 rendering possible connection with a load to be operated, as for example a drive powered by fluid pressure.

The valve device 1 is more particularly operated with compressed air, while however also being suitable for operation with other gases or with liquids.

In accordance with the respective state of operation of the control valves 12 the working ducts 3c are respectively joined either with the supply duct 3a or with the discharge duct 3b.

Dependent on the particular design of the control valves 12 it is possible to implement other valve functionalities as well. For instance the valve units 6 could be in the form of multiway pilot valves, which have a principal valve operated by fluid force, whose operational state is set by at least one electrically operated control valve 12.

The valve units 6 receive their electrical operating signals from a signal transmission means 15 concealed in the valve device 1. It extends in the embodiment in an accommodating passage 16 extending through the valve support 2 in the direction of its longitudinal axis 5. In the condition ready for operation of the valve device 1 the accommodating passage 16 is shut off at the end by a stopper element, not illustrated in detail.

The signal transmission means 15 is electrically joined via electrical interface means 17 with each valve unit 6. The electrical interface means 17 extend through suitable openings 18 in the wall section 22 (extending between the accommodating passage 16 unit component mounting face 4) of the valve support 2.

The signal transmission means 15 may be designed for every normally used type of signal transmission, in particular both for parallel and serial signal transmission.

Via the signal transmission means 15 communication takes place with an external electronic control means, not illustrated in detail. The signal transmission means 15 has for this purpose, more particularly at a terminal portion, a suitable central interface means, as for example a multipole plug device or a field bus connection device (not illustrated).

Each valve unit 6 is provided with two state display units 13. They are able to display certain operational states, (corresponding to the valve units 6) by the supply of light signals optically.

Each of the two control valves 12 is provided with one of the two state display units 23. If only one control valve 12 is present, the number of the state display units 23 may be correspondingly diminished. However in principle it is possible to choose the number of the control valves 23 independently of the number of the control valves 12 or of the other features of the valve unit 6.

For each state display unit 23 there is a light source 24 accommodated in the valve device 1. In the working example each state display unit 23 has its own light source 24. The light source 24 is in a position of emitting electrically produced light signals in a manner dependent on the operational state of the associated valve unit 6. Accordingly it is possible for example to view the switched state of the control valves 12, i.e. whether they are for example currently in an open or a closed position. Furthermore any messages relating to problematical conditions may be optically signaled.

The light source 24 is accommodated in the interior of the valve device 1 in a manner convenient for manufacture, this meaning however that it is concealed from the sight of an outside observer. Its light signals are accordingly not readily visible from the outside. To render the light signals visible each state display unit 23 comprises a light guide 25 so placed in or on the valve device 3 that it conducts the light signals of the light source 24 to a display zone 26 arranged on the outside of the valve device 1. The light signals emitted by the light source 24 are therefore so guided by the light guide 25 that they emerge in the display zone 26 to be visible by an external observer from the valve device 1. The emergence of the light signals is indicated in the drawing at 27 by an arrow.

In the actual example the light sources 24 are designed separately from the valve units 6 and are components of the internal signal transmission means 15. The latter more especially possesses an integral or modularly designed board 28 which at the electrical interface means 17 bears the light sources 24 associated with valve unit 6 connected here, in the case of the working example two for each valve unit 6. Owing to the valve support 2 the light source 24 itself is screened off from the surroundings.

The light guides 25 provided for a respective valve unit 6 are preferably collected together as a structural unit in the form of an integral light guide element 32. This light guide element 32 has an essentially L-like configuration with two first and second limbs 33 and 34 converging at a right angle toward each other. The one limb 33 fits between the component mounting face 4 and the base face 7 between the valve support 3 and the valve unit 6, it having the electrical interface means 17 extending through it. The second limb 34 is seated at a terminal side of the valve unit 6 and extends within the same toward the top side, opposite to the valve support 2, of the valve unit 6. Each light guide 25 is constituted by a section, which conducts light, of the light guide element 32, reflecting faces 36 arranged obliquely to the path of the beam 35, indicated dot-dash lines, of the light signals causing the light beams to shine in the desired direction.

As is more particularly indicated by FIG. 2, the light guides 25 possess a stepped longitudinal form. A first length section 25a extends from the display panel 26 at a right angle to the component mounting face 4 as far as the base face 7, there being an adjoining second length section 25b, which is parallel to the component mounting face 4 and fits between the valve support 2 and the valve unit 7, such light section 25b being followed by a third length section 25c which is again at a right angle to the component mounting face 4 and extends through an opening 37 in the wall section 22 into the accommodating passage 16. The third length section 25c consequently extends from the first limb 33 of the light guide element 32.

The free end of the first length section 25a defines an outer terminal section 38 of the respective light guide 25 at the display zone 26. The opposite third length section 25c defines an inner terminal section 39 of the light guide 25 ending directly adjacent to the associated light source 24. In the working example the arrangement is such that the terminal face of the inner terminal section 39 is opposite to the light source 24 and at a small distance from it.

At this point it is to be observed that the light guides 25 of a valve unit 5 do not necessarily have to be collected together as one structural unit and it is readily possible to have mutually separate components.

The following description considers the case of only one state display unit 23. The corresponding remarks apply in a similar manner for the other state display units 23.

The light source 24 of the state display unit 23 is so designed that when it is turned on it emits polychromatic light. It is more especially a question of white light comprising the entire visible wavelength spectrum. The light is more particularly produced by an LED, although it is also possible to use a plain incandescent lamp.

The use of polychromatic light in lieu of monochromatic light is connected with the fact that the state display unit 23 is intended to produce different visible colors of the light signals. This is made possible by filtering out of light of certain wavelength(s) from the wide spectrum of the polychromatic light made available by the light source 24. Such filtering results from the use of at least one color filter 42, which is placed on the path of the light between the light source 24 and the display area 26.

The color filter 42 could be formed directly by the light guide 25. If for example a light guide dyed red is used, all visible light other than the red light spectrum will be absorbed and on activation of the light source 24 red light will shine at the display zone 26. In a similar fashion as an alternative when using differently dyed light guides it is possible to cause a signal light with a different color to appear.

Preferably and as also the case with the working example, there may be a separation of the functions of light conducting as such and of color filtering. In this case the light guide 25 consists of a material, which preferably allows passage of the full wavelength spectrum of light unfiltered. In this case it is possible to manufacture the light guide of a colorless, transparent plastic material, which may be fashioned in any desired configuration quite simply. The separate color filtration takes place using at least one color filter element 43a and 43b present in addition to the light guide 25 and which is combined or able to be combined with the light guide 25.

In the case of the working example illustrated in full lines a first color filter element 43a is associated with the inner terminal section 39 of the light guide 25. It is seated directly on the light guide 25 and is more especially dome-like in form and can be mounted for fitting in position by a plugging operation on the pin-like inner terminal section 39 of the light guide 25. Owing to this configuration that part of the light guide 25, which without the presence of a first color filter element 43a would be exposed to the light signals of the light source 24, is fully screened off by an optical filter material from the light source 24. The light can therefore shine into light guide 25 only through the first color filter element 43a so that no unfiltered light can enter which would possibly taint the color of the light.

In the example the dome-like first color filter element 43a is inserted from the outside through the wall opening 37 into the valve support 2 so that it extends toward the light source 24 into the accommodating passage 16. A conically widening part 44 at the top end portion opposite to the dome floor prevents it from falling into the accommodating passage 16. A seal ring 45 only indicated in FIG. 3 provides a sealing effect between the outer periphery of the first color filter element 43a and the inner periphery of the wall opening 37 so that neither dirt nor moisture can enter. As an alternative or in addition the seal ring 45 may also serve to hold the first color filter element 43a by friction in the wall opening 37.

In FIG. 2 chained lines serve to indicate that possibly additionally or however instead of the color filter element 43a a second color filter element 43b for example could arranged on the outer terminal section 38 of the light guide 25. If there is no first color filter element 43a the light signals of the light source 24 will therefore shine without optical filtering through the light guide 25 as far as the point of emergence at the display zone 26, where the second color filter element 43b causes the desired color filtering.

The term “first” and “second” filter element are here not to be understood as numerals but only to facilitate a distinction between the different filter elements.

As is the case with the first color filter element 43a it is convenient for the second color filter element 43b to be detachably placed on the light guide 25. It is more particularly possible for it to be plugged in position detachably. This permits simple assembly and if required the replacement with an other color filter element having a different optical filtering action.

As shown in FIG. 2 as regards the second color filter element 43b and as shown in FIG. 3 as regards the first color filter element 43a a double arrow 46 in chained lines serves to indicate the possibility of substitution for the color filter elements 43a and 43b. The invention more particularly contemplates providing several color filter elements with different color filtering effects as a freely movable components of the valve device so that the user himself has the direct possibility of setting the ultimately color, visible at the display zone 26, of the light signals by selective use of a particular color filter element. The light guide 25 itself can always be employed again and does not have to be replaced as well. This makes for a simplification of handling and reduces the costs of production. As regards the color filter elements 43a and 43b it is a rule that they are best made of a transparent material, whose color shade is the same as that of the shade desired for the light signals. Such color filter elements may for example be manufactured of a transparent plastic material, which is dyed with the desired color shade.

By the use of different types of shading in FIG. 3 (used for one and the same valve unit 6) of the first color filter elements 43a the drawing is intended to indicate that within a valve device 1 it is quite possible to combine color filters with different optical filtering effects. For example it is possible to ensure that on activation of the one control valve 12 a light signal in a first color is produced and on activation of the second control valve 12 a light signal with a second color differing therefrom is produced.

It will be apparent that the placement of a filter element 43a and 43b is not restricted to the terminal sections of the light guide 25. The light guide could for example also have a recess between its two terminal sections 38 and 39 in which a color filter element could be mounted.

The color filter elements could in principle be held-on the light guide 25 by their own force, as is depicted in the example in the case of the second color filter element 43b. It is fixed in position by detent means, not illustrated, as part of a releasable detent or catch connection. Other attachment means are also contemplated. For instance a slot might be present into which the color filter element may be slipped.

Apart from the display zone 26 the light guide 25 in the working example is fully screened off from the surroundings, something which is partly due to the valve support 2 and partly to the housing of the valve unit 6.

1. A fluid power device comprising at least one state display unit which possesses a light source arranged in the device in a concealed manner and a light guide for conducting the light signals of the light source to a display zone on the outer side of the device, wherein the light source is designed for emitting polychromatic light and wherein, on the beam path of the light between the light source and the display zone at least one color filter is arranged determining the color, visible at the display zone, of the light signals.

2. The device in accordance with claim 1, wherein the color filter for altering the light color visible at the display zone is adapted to be exchangable.

3. The device in accordance with claim 2, wherein several color filters with mutually different filtering effects are present which are able to be placed alternatively on the beam path of the light in order to alter the light color visible at the display zone.

4. The device in accordance with claim 1, wherein the color filter is designed as a color filter element present in addition to the light guide.

5. The device in accordance with claim 4, wherein the color filter element is arranged directly on the light guide.

6. The device in accordance with claim 5, wherein the light guide supports the color filter element.

7. The device in accordance with claim 4, wherein, for altering the light color, visible at the display zone, the color filter element is able to be exchanged independently of the light guide for a color filter element having a different filter effect.

8. The device in accordance with claim 4, wherein the light guide consists of a material conducting light in the full visible wavelength spectrum without filtration.

9. The device in accordance with claim 8, wherein the light guide consists of a colorless and transparent plastic material.

10. The device in accordance with claim 4, wherein the color filter element is disposed in the interior of the device on the inner terminal section associated with the light source, of the light guide.

11. The device in accordance with claim 4, wherein the color filter element is disposed on the outer terminal section, associated with the display zone, of the light guide.

12. The device in accordance with claim 10, wherein the color filter element is dome-like in form and is mounted on a pin-like terminal section of the light guide.

13. The device in accordance with claim 4, wherein the color filter element is releaseably plugged on the light guide.

14. The device in accordance with claim 1, wherein the color filter consists of a colored, transparent material.

15. The device in accordance with claim 1, further comprising a plurality of state display units which are simultaneously present.

16. The device in accordance with claim 15, wherein the light guides of several state display units are collected together in one light guide element as a single structural unit.

17. The device in accordance with claim 1, wherein the fluid power device an electrically operated valve device serving for the control of fluid flows.

18. The device in accordance with claim 17, wherein the electrically optical valve device comprises a valve support having valve support fluid ducts extending through it, and at least one electrically operated valve unit mounted on the valve support and communicating with at least one of the valve support fluid ducts, the light source of the at least one state display unit being arranged in the valve support and the light guide fitting into the area between the valve unit and the valve support.

19. The device in accordance with claim 18, wherein the light guide is a component of an essentially L-shaped light guide element having a first limb fitting in between the valve unit and the valve support and having a second limb extending toward the display zone in the terminal area of the valve unit.
